(19) United States
(12) Patent Application Publication
(10) Pub. No.: US 2018/0357230 A1
(43) Pub. Date: Dec. 13, 2018

(54) IMPLEMENTATION METHOD OF INTERLINKED DOCUMENT

(71) Applicant: FUJIAN FOXIT SOFTWARE DEVELOPMENT JOINT STOCK CO. LTD., Fuzhou City (CN)

(72) Inventors: Yuqian Xiong, Fuzhou City (CN); Hongying Lian, Fuzhou City (CN)

(21) Appl. No.: 16/060,440

(22) PCT Filed: Dec. 21, 2016
(86) PCT No.: PCT/CN2016/000701

§ 371 Date: Jun. 8, 2018

(30) Foreign Application Priority Data
Dec. 31, 2015 (CN) 201511028200.9

(51) Int. Cl. G06F 17/30; G06F 17/22

(52) U.S. Cl. CPC G06F 17/30014; G06F 17/2235; G06F 17/30902

(57) ABSTRACT

An implementation method of an interlinked document includes requesting a cloud server to acquire interlink ID identification information upon creating a document, and storing, in the document, the interlink ID identification information uniquely corresponding to the document and dispatched by the cloud server, such that the document becomes an interlinked document; storing, on the cloud server, related data information of the interlinked document comprising information of creation, distribution, modification, historical circulation, or permission of the document, and automatically updating the corresponding related data information on the cloud server upon changing of the information of distribution, modification, historical circulation, or permission of the interlinked document; and when a user opens the acquired interlinked document with a client, automatically extracting, by the client, the interlink ID identification information in the interlinked document, and downloading, according to the extracted interlink ID identification information, the corresponding related data information from the cloud server.

### TECHNICAL FIELD

The present disclosure relates to the field of document management, and in particular to a technical field of a document information interconnection method.

### BACKGROUND

Traditional documents are individual documents, which are static and separate. An amended version of a document, which has been modified, is also independent of an original version of the document. And the amended version of the document has not any correlation to the original version of the document. Therefore, it is inconvenient for a user to know information of a dynamic distribution history of such documents.

### SUMMARY OF THE INVENTION

The present disclosure provides a document information interconnection method, which is used for tracking the dynamic distribution history of the interconnected documents, for performing an effective, secure and long-distance manipulation and protection on the interconnected documents which are distributed, and for actually realizing a safe management of the documents in a whole process.

To achieve the above object, the present disclosure provides a document information interconnection method, comprising the following steps:

requesting a cloud server to acquire interconnection ID identification information when a document is created, and storing, in the document, the interconnection ID identification information which is uniquely corresponding to the document and is dispatched by the cloud server, such that the document becomes an interconnected document;

storing, in the cloud server, related data information of the interconnected document comprising document creation information, document distribution information, document modification information, document historical circulation information, and document authority information, and automatically updating the corresponding related data information in the cloud server when the document creation information, the document distribution information, the document modification information, the document historical circulation information, and the document authority information of the interconnected document, which correspond to the related data information, are changed, wherein, the cloud server stores according to a one-to-one correspondence principle between the interconnection ID identification information and the related data information of the corresponding document;

and when a user opens the acquired interconnected document with a client, automatically extracting, by the client, the interconnection ID identification information in the interconnected document, and downloading, according to the extracted interconnection ID identification information, the corresponding related data information from the cloud server.

Further, the above-mentioned document information interconnection method further comprising the following steps:

downloading, by the user, a new version or historical version(s) of the interconnected document according to the downloaded related data information.

Further, the above-mentioned document information interconnection method further comprising the following steps:

automatically sending to the cloud server, by the client, operational information about how the interconnected document is operated by the user, and updating the corresponding related data information of the interconnected document in the cloud server, wherein, the operational information comprises at least one of the following: reviewing, modifying, redistributing, and filling a form.

Further, the above-mentioned document information interconnection method further comprising the following steps:

extracting information related to a publisher and historical browsing user(s) in the related data information when the related data information in the cloud server, which corresponds to a certain interconnected document, is changed, and sending the changing information of the related data information, which corresponds to the certain interconnected document, to a client of the publisher and client(s) of the historical browsing user(s) for reminding.

Further, the interconnected document is a PDF document.

Further, the above-mentioned document information interconnection method further comprising the following steps:

when a user opens the interconnected document with a application program that is incompatible with the interconnected document, popping up a prompting by javascripts in the interconnected document, and recommending the user to use a compatible application program to acquire functions of the interconnected document.

According to the present disclosure, by way of authenticating a document as an interconnected document, and interrelating the static and individual documents on a global scale, the interrelations between documents and documents, documents and people, documents and systems, relying on cloud services, can be realized, which is used for tracking the dynamic distribution history of the interconnected documents, for performing an effective, secure and long-distance manipulation and protection on the interconnected documents which are distributed, and for actually realizing a safe management of the documents in a whole process.

### BRIEF DESCRIPTION OF THE DRAWINGS

In order to more clearly illustrate the technical solutions in the embodiments of the present disclosure or in the prior art, the drawings used in the description of the embodiments or in the prior art will be briefly described below. Obviously, the drawings in the following description are only some embodiments of the present disclosure, for those having ordinary skills in the art, other drawings may also be obtained based on these drawings without making creative work.

FIG. 1 is a flow chart of a document information interconnection method according to an embodiment of the present disclosure;

FIG. 2 is a schematic diagram of an implementation method of an interconnected PDF document according to an embodiment of the present disclosure.

### DETAILED DESCRIPTION OF THE EMBODIMENTS

The technical solutions in the embodiments of the present disclosure will be clearly and completely described below with reference to the accompanying drawings in the embodiments of the present disclosure. Obviously, the described embodiments are merely a part of embodiments of the present disclosure, rather than all embodiments thereof. Based on the embodiments in the present disclosure, all other embodiments obtained by those having ordinary skills in the art without making creative work fall within the protection scope of the present disclosure.

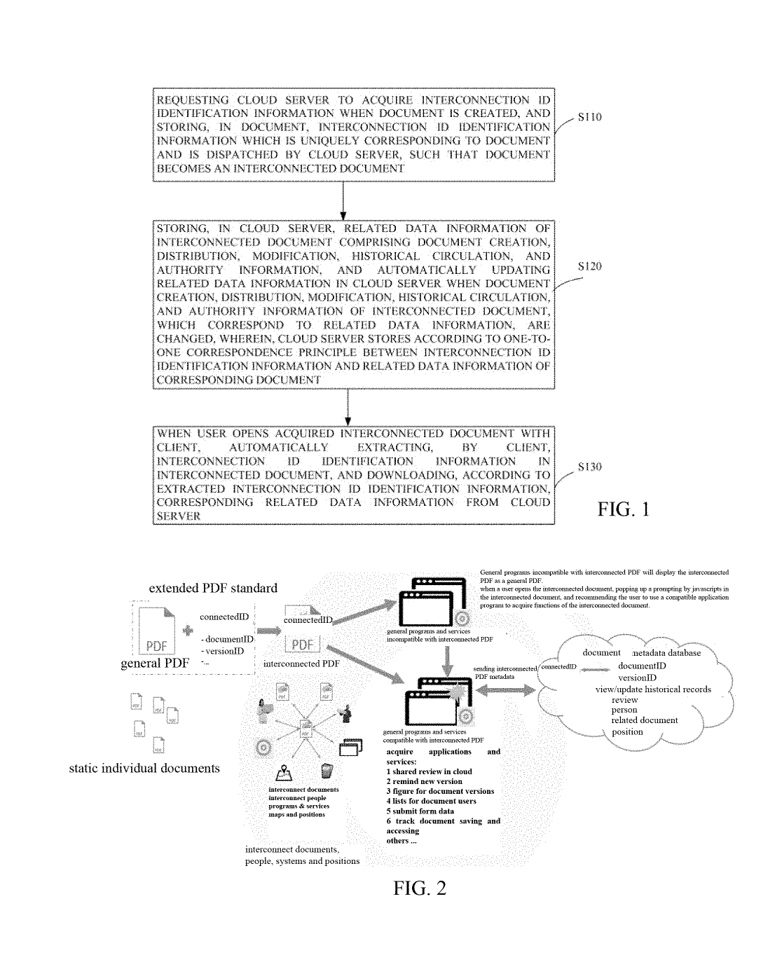

FIG. 1 is a flow chart of a document information interconnection method according to an embodiment of the present disclosure; as shown in the FIG. 1, the document information interconnection method comprising the following steps:

S110: requesting a cloud server to acquire interconnection ID identification information when a document is created, and storing, in the document, the interconnection ID identification information which is uniquely corresponding to the document and is dispatched by the cloud server, such that the document becomes an interconnected document;

S120: storing, in the cloud server, related data information of the interconnected document comprising document creation information, document distribution information, document modification information, document historical circulation information, and document authority information, and automatically updating the related data information in the cloud server when the document creation information, the document distribution information, the document modification information, the document historical circulation information, and the document authority information of the interconnected document, which correspond to the related data information, are changed, wherein, the cloud server stores according to a one-to-one correspondence principle between the interconnection ID identification information and the related data information of the corresponding document;

and S130: when a user opens the acquired interconnected document with a client, automatically extracting, by the client, the interconnection ID identification information in the interconnected document, and downloading, according to the extracted interconnection ID identification information, the corresponding related data information from the cloud server.

To facilitate a user to review different versions of an interconnected document, the above-mentioned document information interconnection method further comprising the following steps:

downloading, by the user, a new version or historical version(s) of the interconnected document according to the downloaded related data information.

To real-timely and automatically update the related data information of an interconnected document, the above-mentioned document information interconnection method further comprising the following steps:

automatically sending to the cloud server, by the client, operational information about how the interconnected document is operated by the user, and updating the corresponding related data information of the interconnected document in the cloud server, wherein, the operational information includes at least one of the following: reviewing, modifying, redistributing, and filling a form.

To facilitate a user to understand the changing information of an interconnected document, the above-mentioned document information interconnection method further comprising the following steps:

extracting information related to a publisher and historical browsing user(s) in the related data information when the related data information in the cloud server, which corresponds to a certain interconnected document, is changed, and sending the changing information of the related data information, which corresponds to the certain interconnected document, to a client of the publisher and client(s) of the historical browsing user(s) for reminding.

To facilitate a user to use the functions of an interconnected document, the above-mentioned document information interconnection method further comprising the following steps:

when a user opens the interconnected document with a application program that is incompatible with the interconnected document, popping up a prompting by javascripts in the interconnected document, and recommending the user to use a compatible application program to acquire functions of the interconnected document.

For example, when an interconnected document is a PDF document, the PDF standard is extended. And a new document format is developed by a further research on an exchange of PDF documents.

The interconnected PDF is a PDF document that is assigned by a cloud with a globally unique interconnection ID (named as an English name of “Connected ID”) which is embedded in the interconnected PDF document. The interconnected PDF document associates the static and individual documents with each other. And multiple documents with the same interconnection ID are connected together by an identification technology, so as to facilitate a user to understand the information of the dynamic distribution history of such documents.

The interconnected PDF document is assigned the Connected ID identity information by the cloud. The Connected ID is a unique identity information of the document on a global range. The document is connected to the cloud by the Connected ID. And related data information of the document is stored or extracted. The related data information comprises document creation information, document distribution information, document modification information, document historical circulation information, and document authority information, etc. And related document management cloud services are acquired from the related data information.

FIG. 2 is a schematic diagram of an implementation method of an interconnected PDF document according to an embodiment of the present disclosure. The clients referred to in this method are clients that can support the interconnected PDF format, specifically comprising the following steps:

creating PDF documents by a publisher with the client, wherein documents in other formats can usually be converted to documents in a PDF format;

automatically requesting, by the client, a Connected ID for the PDF document from the cloud server, and imbedding the acquired Connected ID into the PDF document;

distributing, by the publisher, the created interconnected PDF document to the recipient;

opening, by a recipient, the interconnected PDF document, wherein the client automatically extracts the Connected ID from the interconnected PDF document, and sends the Connected ID to the cloud server;

retrieving, by the cloud server, related data information corresponding to the interconnected PDF document based on the received Connected ID, and returning the related data information to the client;

after the client receives the related data information, carrying out operations such as downloading, reviewing, modifying, redistributing, and filling a form for the new version of the interconnected PDF document by the recipient.

automatically sending, by the client, the modified information to the cloud server, and saving the modified information under the same Connected ID; and

acquiring, by the publisher, the updated related data information from the cloud according to the Connected ID.

In summary, the above embodiment of the present disclosure achieves the following advantageous effects:

According to the present disclosure, by way of authenticating a document as an interconnected document, and by means of the cloud, multiple documents with the same Connected ID are connected together to classify and manage. The present disclosure facilitates the user to trace the dynamic distribution process of the same interconnected document. The present disclosure realizes a whole process management of the document. And the present disclosure makes a flexible document system.

It can be understood by those having ordinary skills in the art that the drawings are only schematic diagrams of an embodiment, and the modules or processes in the drawings are not necessary to implement the present disclosure.

It can be understood by those having ordinary skills in the art that the modules in the apparatus of the embodiment may be distributed in the apparatus of the embodiment according to the description thereof, and may also be correspondingly changed to be positioned in one or more apparatus different from those of the present embodiment. The modules of the above embodiments may be combined into one module, and may also be further divided into multiple sub-modules.

Finally, it should be noted that the above embodiments are only used to illustrate the technical solutions of the present disclosure, rather than limiting the same; although the present disclosure has been described in detail with reference to the foregoing embodiments, those having ordinary skills in the art should understand that: the technical solutions described in the foregoing embodiments can still be modified, or a part of the technical features therein can be equivalently substituted; and these modifications or substitutions will not make the corresponding technical solutions essentially depart from the spirit and scope of the technical solutions of the embodiments of the present disclosure.

1. A document information interconnection method, comprising the following steps:
requesting a cloud server to acquire interconnection ID identification information when a document is created, and storing, in the document, the interconnection ID identification information which is uniquely corresponding to the document and is dispatched by the cloud server, such that the document becomes an interconnected document;
storing, in the cloud server, related data information of the interconnected document comprising document creation information, document distribution information, document modification information, document historical circulation information, and document authority information, and automatically updating the related data information in the cloud server when the document creation information, the document distribution information, the document modification information, the document historical circulation information, and the document authority information of the interconnected document, which correspond to the related data information, are changed, wherein, the cloud server stores according to a one-to-one correspondence principle between the interconnection ID identification information and the related data information of the corresponding document;
and when a user opens the acquired interconnected document with a client, automatically extracting, by the client, the interconnection ID identification information in the interconnected document, and downloading, according to the extracted interconnection ID identification information, the corresponding related data information from the cloud server.

2. The document information interconnection method according to claim 1, further comprising the following steps:
downloading, by the user, a new version or historical version(s) of the interconnected document according to the downloaded related data information.

3. The document information interconnection method according to the claim 1, further comprising the following steps:
automatically sending to the cloud server, by the client, operational information about how the interconnected document is operated by the user, and updating the corresponding related data information of the interconnected document in the cloud server, wherein, the operational information comprises at least one of the following: reviewing, modifying, redistributing, and filling a form.

4. The document information interconnection method according to the claim 1, further comprising the following steps:
extracting information related to a publisher and historical browsing user(s) in the related data information when the related data information in the cloud server, which corresponds to a certain interconnected document, is changed, and sending the changing information of the related data information, which corresponds to the certain interconnected document, to a client of the publisher and client(s) of the historical browsing user(s) for reminding.

5. The document information interconnection method according to the claim 1, wherein the interconnected document is a PDF document.

6. The document information interconnection method according to the claim 1, further comprising the following steps:
when a user opens the interconnected document with a application program that is incompatible with the interconnected document, popping up a prompting by javascripts in the interconnected document, and recommending the user to use a compatible application program to acquire functions of the interconnected document.

7. The document information interconnection method according to the claim 2, further comprising the following steps:
automatically sending to the cloud server, by the client, operational information about how the interconnected document is operated by the user, and updating the corresponding related data information of the interconnected document in the cloud server, wherein, the operational information comprises at least one of the following: reviewing, modifying, redistributing, and filling a form.
